(19) United States
(12) Patent Application Publication
(10) Pub. No.: US 2015/0063139 A1
(43) Pub. Date: Mar. 5, 2015

(54) Apparatus and Method for Interference Management between Cellular and Local Area Networks

(71) Applicants: Zhi Zhang, Beijing (CN); Yixue Lei, Beijing (CN); Kodo Shu, Beijing (CN)

(72) Inventors: Zhi Zhang, Beijing (CN); Yixue Lei, Beijing (CN); Kodo Shu, Beijing (CN)

(73) Assignee: Nokia Corporation, Espoo (FI)

(21) Appl. No.: 14/382,293

(22) PCT Filed: Mar. 19, 2012
(86) PCT No.: PCT/CN2012/072552

§ 371 Date: Aug. 29, 2014

(51) Int. Cl. H04W 72/04; H04W 24/08

(52) U.S. Cl. CPC H04W 72/04; H04W 24/08
USPC 370/252; 370/329

(57) ABSTRACT

According to an example embodiment of this application, a method may include determining a distance from a network element; and assigning at least one of a downlink resource or an uplink resource to the network element based at least in part on the determined distance, wherein the assigned resource is used for both a downlink and an uplink communication of the network element.

### TECHNICAL FIELD

The present application relates generally to an apparatus and a method for interference management between cellular and local area networks.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application.

In wireless communication, different collections of communication protocols are available to provide different types of services and capabilities. Long term evolution, LTE, is one of such collection of wireless communication protocols that extends and improves the performance of existing universal mobile telecommunications system, UMTS, protocols and is specified by different releases of the standard by the 3^{rd} generation partnership project, 3GPP, in the area of mobile network technology. Other non-limiting example wireless communication protocols include global system for mobile, GSM, high speed packet access, HSPA, and worldwide interoperability for microwave access, WiMAX.

The improvements of LTE are being made to cope with continuing new requirements and the growing base of users. Goals of this broadly based project include improving communication efficiency, lowering costs, improving services, making use of new spectrum opportunities, and achieving better integration with other open standards and backwards compatibility with some existing infrastructure that is compliant with earlier standards. The project envisions a packet switched communications environment with support for such services as voice over IP, VoIP. The 3GPP LTE project is not itself a standard-generating effort, but will result in new recommendations for standards for the UMTS. Recently, the project moved to planning the next generation standards, sometimes referred to as LTE-Advanced, LTE-A.

A goal of LTE-A is to provide significantly enhanced services by means of higher data rates and lower latency with reduced cost. LTE-A is directed toward extending and optimizing the current 3GPP LTE radio access technologies to provide higher data rates at very low cost. LTE-A will be a more optimized radio system fulfilling the international telecommunication union radiocommucation sector, ITU-R, requirements for international mobile telecommunications—advanced, IMT-A, while maintaining backward compatibility with the current LTE release.

LTE-LAN, or LTE-Local Area Network, has been studied for LTE-A. Originally, LTE-LAN aims to provide local area, LA, coverage for indoor residential and enterprise usage with fixed deployment. In such a scenario, a LTE-LAN AP, or access point, provides LTE-based wireless connections to local area devices. The LTE-LAN AP is connected to the core network, CN, via a S1 interface, for example. The mobile terminals establish radio connections with LTE-LAN AP or macro evolved Node B, eNB. This kind of architecture is suitable for fixed deployment in residential and enterprise environment. In addition to the fixed deployment, other type of LTE-LAN architecture is also considered, for example portable LTE-LAN AP.

### SUMMARY

Various aspects of examples of the invention are set out in the claims.

According to a first aspect of the present invention, there is provided a method comprising determining a distance from a network element; and assigning at least one of a downlink resource or an uplink resource to the network element based at least in part on the determined distance, wherein the assigned resource is used for both a downlink and an uplink communication of the network element.

According to a second aspect of the present invention, there is provided an apparatus comprising at least one processor, and at least one memory including computer program code, wherein the at least one memory and the computer program code configured to, with the at least one processor, cause the apparatus to determine a distance from a network element; and assign at least one of a downlink resource or an uplink resource to the network element based at least in part on the determined distance, wherein the assigned resource is used for both a downlink and an uplink communication of the network element.

According to a third aspect of the present invention, there is provided a computer program product comprising a computer-readable medium bearing computer program code embodied therein for use with a computer, the computer program code may include code for determining a distance from a network element; and code for assigning at least one of a downlink resource or an uplink resource to the network element based at least in part on the determined distance, wherein the assigned resource is used for both a downlink and an uplink communication of the network element.

According to a fourth aspect of the present invention, there is provided an apparatus comprising a means for determining a distance from a network element; and a means for assigning at least one of a downlink resource or an uplink resource to the network element based at least in part on the determined distance, wherein the assigned resource is used for both a downlink and an uplink communication of the network element.

According to a fifth aspect of the present invention, there is provided a method comprising receiving an assignment of resource from a network element, wherein the resource is at least one of a downlink resource or an uplink resource of the network element; and applying the resource for both a downlink and an uplink communication with a device.

According to a sixth aspect of the present invention, there is provided an apparatus comprising at least one processor, and at least one memory including computer program code, wherein the at least one memory and the computer program code configured to, with the at least one processor, cause the apparatus to receive an assignment of resource from a network element, wherein the resource is at least one of a downlink resource or an uplink resource of the network element; and apply the resource for both a downlink and an uplink communication with a device.

According to a seventh aspect of the present invention, there is provided a computer program product comprising a computer-readable medium bearing computer program code embodied therein for use with a computer, the computer program code may include code for receiving an assignment of resource from a network element, wherein the resource is at least one of a downlink resource or an uplink resource of the network element; and code for applying the resource for both a downlink and an uplink communication with a device.

According to an eighth aspect of the present invention, there is provided an apparatus comprising a means for a means for receiving an assignment of resource from a network element, wherein the resource is at least one of a downlink resource or an uplink resource of the network element; and a means for applying the resource for both a downlink and an uplink communication with a device.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates a spectrum allocation for frequency division duplexing system according to an example embodiment of the application;

FIG. 3 illustrates a flow diagram of interference suppression according to an example embodiment of the application, where a portable long term evolution local area network, LTE-LAN, is far from a macro evolved Node B, eNB,;

FIG. 4 illustrates a flow diagram of interference suppression according to an example embodiment of the application, where a portable LTE-LAN is at a middle distance from a macro eNB;

FIG. 5 illustrates a flow diagram of interference suppression according to an example embodiment of the application, where a portable LTE-LAN is near to a macro eNB;

FIG. 6 illustrates a flow diagram of interference suppression according to an example embodiment of the application, where a portable LTE-LAN is near to a macro eNB and uses same modulation scheme as the macro uplink.

FIG. 7 illustrates a flow diagram of operating a macro eNB according to an example embodiment of the application.

FIG. 8 illustrates a flow diagram of operating a LTE-LAN access point according to an example embodiment of the application.

FIG. 9 illustrates a simplified block diagram of various example apparatuses that are suitable for use in practicing various example embodiments of this application.

### DETAILED DESCRIPTION

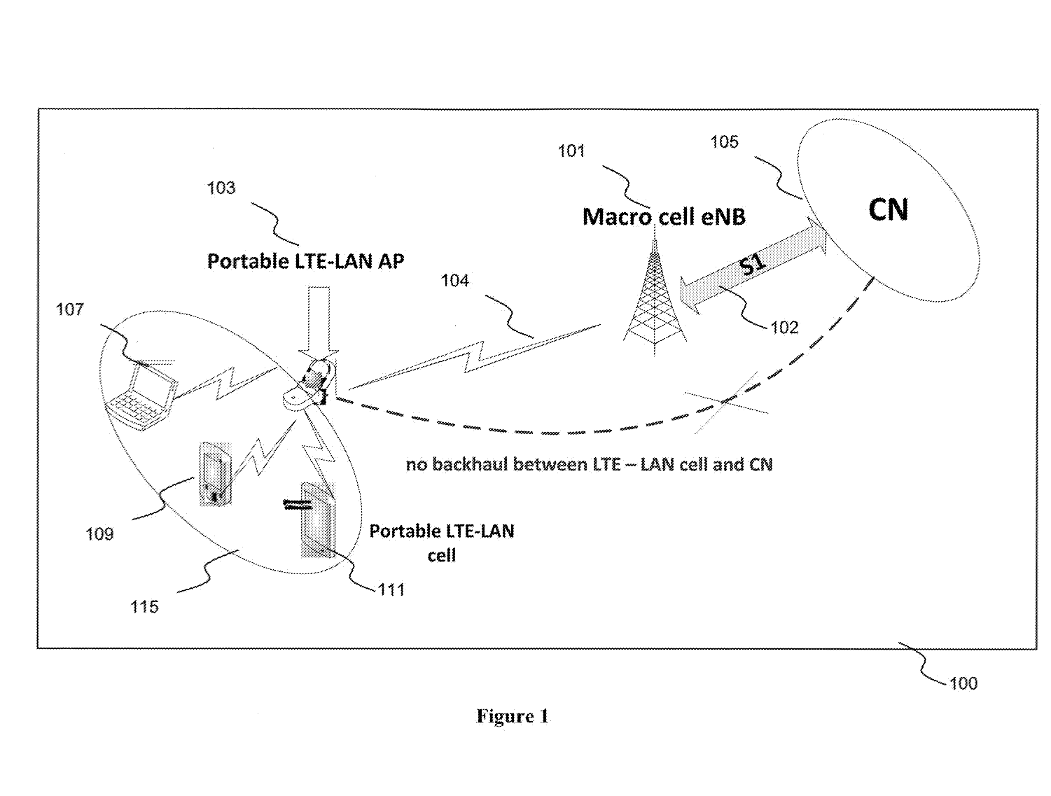

FIG. 1 illustrates an example wireless system 100 in accordance with an example embodiment of the application. The example wireless system 100 comprises a 3rd generation partnership project, 3GPP, macro cell evolved NodeB, eNB, 101 and a portable long term evolution, LTE, local area network, LAN, access point, AP, LTE-LAN AP 103. The macro cell eNB 101 connects to a core network, CN, 105 via an interface 102, which may comprise, for example, a S1-like interface, and may be configured to communicate with one or more user equipment, UE, that are not shown in FIG. 1. The portable LTE-LAN AP 103 is connected with the macro cell eNB 101 via a wireless link 104, and is configured to provide wireless connections to devices in the portable LTE-LAN local area 115, such as for example devices 107, 109 and 111 in FIG. 1. In an example embodiment, the LTE-LAN AP 103 may be considered as a regular UE or wireless modem from the point of view of the macro cell eNB 101. Although just one macro cell eNB, one LTE-LAN AP and three local devices are shown in FIG. 1, the example wireless system 100 may comprise more or less eNBs, LTE-LAN APs and UEs.

In an example embodiment, the LTE-LAN AP 103 may be embedded into a portable or mobile device and access CN 105 through a cellular link as a normal UE. Such kind of architecture assumption may be suitable for a portable LTE-LAN architecture because in this way LTE or system architecture evolution, SAE, specifications may not need to change if LTE-LAN AP is regarded as a regular DE from macro eNB perspective, although it may be actually a combination of a UE and a portable LTE-LAN AP. A signaling connection between portable LTE-LAN cell and CN, such as for example an S1-like interface for femto or Un-like interface for relay, may not be necessary. This means that the portable LTE-LAN cell could be transparent to CN. By LTE-LAN cell it is meant a cell served by a LTE-LAN AP. The traffic from devices 107, 109 and 111 to LTE-LAN AP 103 may be multiplexed to data radio bearers, (DRBs, so CN does not need to be aware of the LTE-LAN cell 115 and the local radio bearers between portable LTE-LAN AP and UE in the local area network.

A portable LTE-LAN cell may support more reliable data transmission over licensed spectrum, compared to WiFi, for example. A portable LTE-LAN AP may enable data exchange among cellular devices in a local area network without introducing physical layer changes to device to device, D2D communication capable devices configured to operate in accordance with, for example, 3GPP LTE-A. With D2D communication it is meant direct communication between user equipments or portable access points that does not traverse any base station apparatus. With such kind of architecture assumption, some local area specific features can be realized. Compared with a wide area coverage, such as that of a macro cell, a local area network has more limited coverage, which means that a very low transmit power from both AP and UE may be sufficient for reliable communication. In this sense, local area specific optimizations can be expected, such as uplink, UL, and downlink, DL, similarity, in other words UL and DL may apply a same modulation scheme so that a similar chipset implementation as well as similar reference signals, RS, and physical channel structure can be applied for both UL and DL. UL and DL similarity can simplify the design of local area networking, such as for example design of a LTE-LAN. For example, one option may be that orthogonal frequency division multiple access, OFDMA, is applied for both UL and DL; the other option may be that single carrier frequency division multiple access, SC-FDMA, which may also named as Discrete Fourier Transform-Spread-OFDMA, DFT-S-OFDMA, is applied for both UL and DL.

For resource allocation, such as for example, spectrum allocation, one may assign different frequency bands for a LTE-LAN and a macro cell, respectively. However this solution may not be cost efficient from spectrum usage perspective, for example when the LTE-LAN and the macro cell are both in frequency division duplexing, FDD, mode. If a portable LTE-LAN and the macro cell share the same resource, for example the frequency band, or a subframe in a time division duplexing, TDD, mode, co-channel interference between the portable LTE-LAN and the macro cell may need to be taken care of, considering that the location of the portable LTE-LAN could be anywhere inside the macro cell.

The portable LTE-LAN can work in either FDD mode or TDD, mode. In another words, at least one of the downlink and uplink communication between a LTE-LAN AP, such as for example the LTE-LAN AP 103 of FIG. 1, and a LTE-LAN UE, such as for example device 107, 109 or 111 of FIG. 1, can be either frequency duplexed or time duplexed. In an example embodiment, for TDD mode, the UL and DL may both use OFDMA and have the same demodulation reference signal, DMRS, structure/pattern. In another example embodiment, the UL and DL may both use SC-FDMA and have the same DMRS structure/pattern. With small transmit power on uplink, peak to average power ratio, PAPR, may not be severe in a local area network.

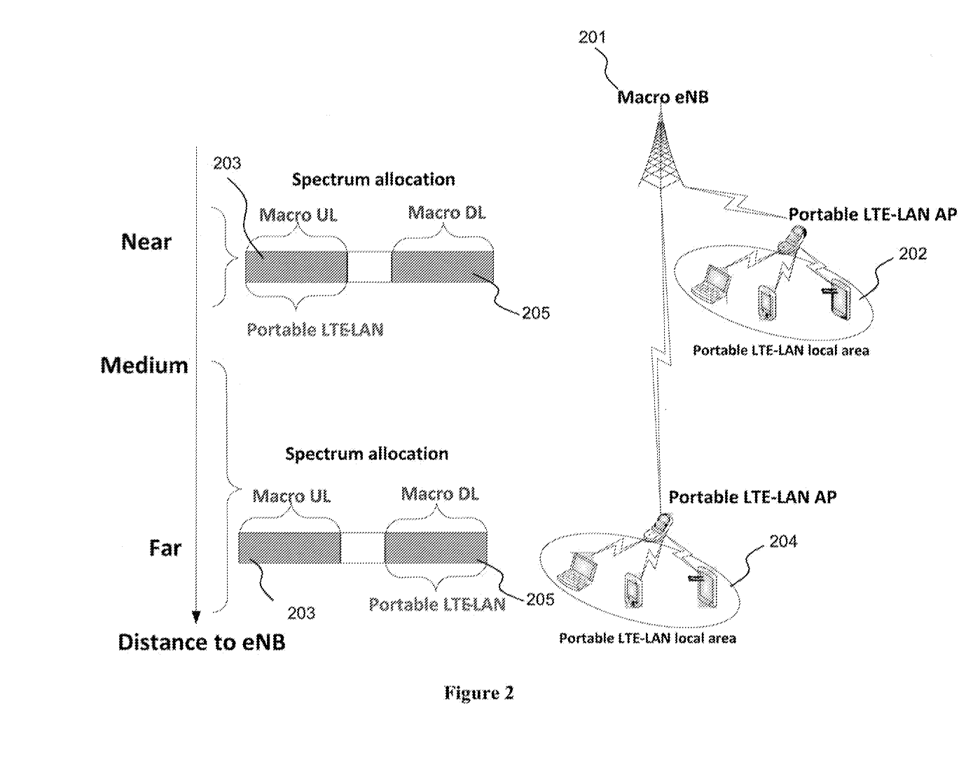

FIG. 2 illustrates a spectrum allocation for a FDD system according to an example embodiment of the application. In the example embodiment of FIG. 2, for far to medium distance to a macro eNB 201, a portable LTE-LAN 204 is assigned to the DL resource 205 of the macro cell, while for near distance to the macro eNB 201, a portable LTE-LAN 202 is assigned to the UL resource 203 of the macro cell. In other words, in the illustrated embodiment the resource assigned to a LTE-LAN depends on a distance between the LTE-LAN and a macro base station, such as for example an eNB. The resource can be, for example, a frequency band, such as for example a FDD frequency band as shown in FIG. 2. In an example embodiment, a resource allocation specific co-channel interference suppression/avoidance mechanism may be applied to further reduce the co-channel interference between the LTE-LAN and the macro cell. In an example embodiment, if LTE-LAN is assigned to an UL resource of a macro cell, there may be no need for LTE-LAN AP or UE to prepare interference suppression or measurement. In an example embodiment, if LTE-LAN is assigned to a DL resource of a macro cell, the macro eNB and the LTE-LAN UE can transmit to LTE-LAN AP simultaneously which may ease the LTE-LAN AP's scheduling.

In an example embodiment, a near distance may be defined to be a range from a macro eNB where the major part of co-channel interference is from macro eNB DL. Likewise, a far distance may be defined to be a range from a macro eNB where the major part of co-channel interference is from UL macro transmission. Accordingly, a medium distance may be defined as intermediate distance range between the near distance and the far distance. An example of this is a distance at which co-channel interference from macro DL and macro UL provide similar contributions to overall co-channel interference. An example of such similar contributions is a distance at which macro DL contributes 40% and macro UL contributes 60% of overall co-channel interference. In another example embodiment, the portable AP or MeNB can determine the distance between them from downlink broadcasting signals, such as common reference signal, CRS, or channel state information reference signal, CSI-RS, of macro cell. For example, the portable AP may measure and report the signal strength of macro cell's CRS, if the measured signal strength exceeds the transmission power of the portable AP over a first predetermined threshold, the MeNB can decide that this portable AP is near to the MeNB; on the contrary, when the power difference between the measured signal strength of macro cell and the transmission power of portable AP is less than a second predetermined threshold, the MeNB can decide that this portable AP is far from the MeNB; otherwise, the portable AP can be considered to be in the medium distance to from the MeNB. In another example embodiment, the measured signal strength of the MeNB, instead of the power difference between the measured signal strength and the transmission power of portable AP, is compared with at least one of a first and a second predetermined threshold to determine the distance.

In an example embodiment, if a portable LTE-LAN is far from a macro eNB, MeNB, a major component of co-channel interference may be from a nearby macro UE on the UL since the macro UE may use a high tranmit power near a macro cell boundary. In this case, portable LTE-LAN may be assigned to a DL resource of the macro cell to avoid UL co-channel interference from the nearby macro UE. If MeNB DL uses OFDMA, LTE-LAN UL and DL both using OFDMA can further reduce the co-channel interference between LTE-LAN and macro eNB DL transmission with a co-channel interference suppression mechanism, such as for example, an interference rejection combining scheme.

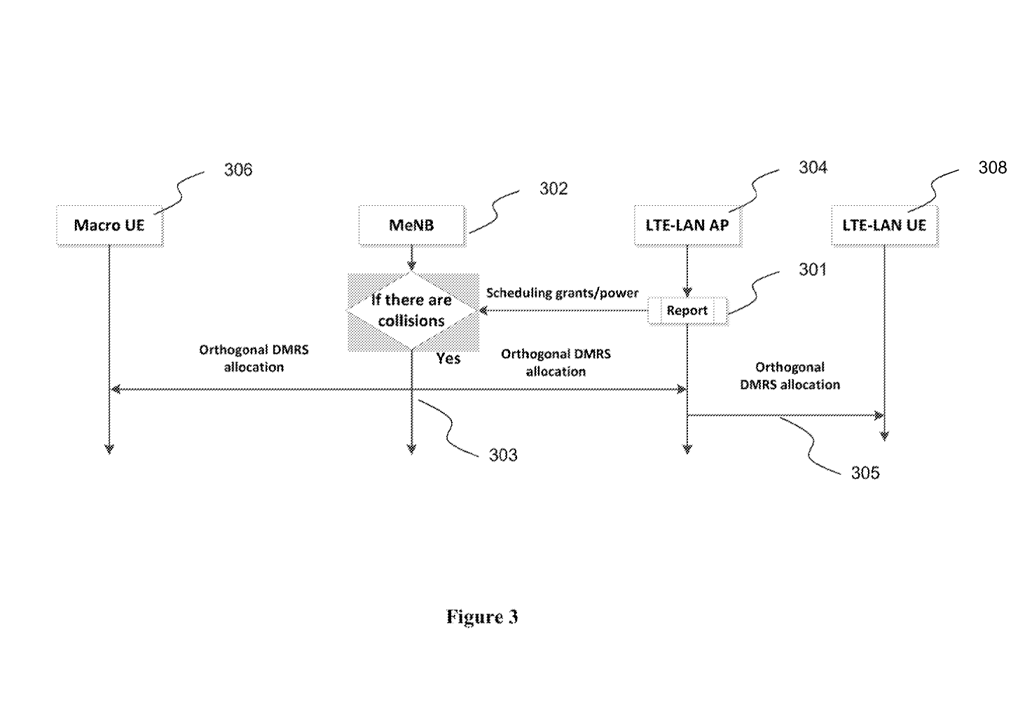

FIG. 3 illustrates a flow diagram of interference suppression according to an example embodiment of the application, where a portable LTE-LAN is far from a macro eNB. In FIG. 3, a portable LTE-LAN is assigned to a DL resource of the macro cell, such as for example a DL spectrum band or a DL subframe of the macro cell. At 301, a portable LTE-LAN AP 304 may report to a macro eNB 302 the radio resource that it may assign or use. The radio resource can be, for example, a scheduling grant assigned to individual LTE-LAN UEs 308 under the coverage of the LTE-LAN AP 304, or a transmission power of the LTE-LAN AP 304. If there is a transmission collision between LTE-LAN and the downlink of macro eNB, MeNB 302 may assign orthogonal DMRS at 303 to LTE-LAN AP 304 and a corresponding macro cell downlink channel for macro UE 306, such as for example a physical downlink shared channel, PDSCH. The LTE-LAN AP 304 can use at 305 the assigned orthogonal DMRS for its LTE-LAN downlink or/and uplink channels, such as for example PDSCH or/and physical uplink shared channel, PUSCH. In an example embodiment, MeNB 302 can also indicate a proper power level to LTE-LAN, to prevent too low or too high power of LTE-LAN. A proper power level may be expressed in dBm units, for example. In an example embodiment, the LTE-LAN AP 304 and MeNB 302 may instruct their corresponding UEs 308 and 306 to utilize interference rejection combining, IRC, receivers to reject interference through orthogonal DMRS.

In an example embodiment, if a portable LTE-LAN is at a medium distance from a macro eNB, the major co-channel interference can be either from a nearby macro UE UL link or from MeNB DL link, depending on which macro resource is assigned to the portable LTE-LAN. If LTE-LAN modulation and reference signal, RS, structures are aligned to macro DL link, it may be easier to mitigate co-channel interference between LTE-LAN and MeNB DL link, compared with interference mitigation between LTE-LAN and macro UE UL link. So portable LTE-LAN may be assigned to a macro cell DL resource. If MeNB DL uses OFDMA, LTE-LAN UL and DL may both use OFDMA to avoid UL co-channel interference from nearby macro UE, and corresponding interference suppression mechnisms may be applied to prevent MeNB DL from generating too much interference to LTE-LAN.

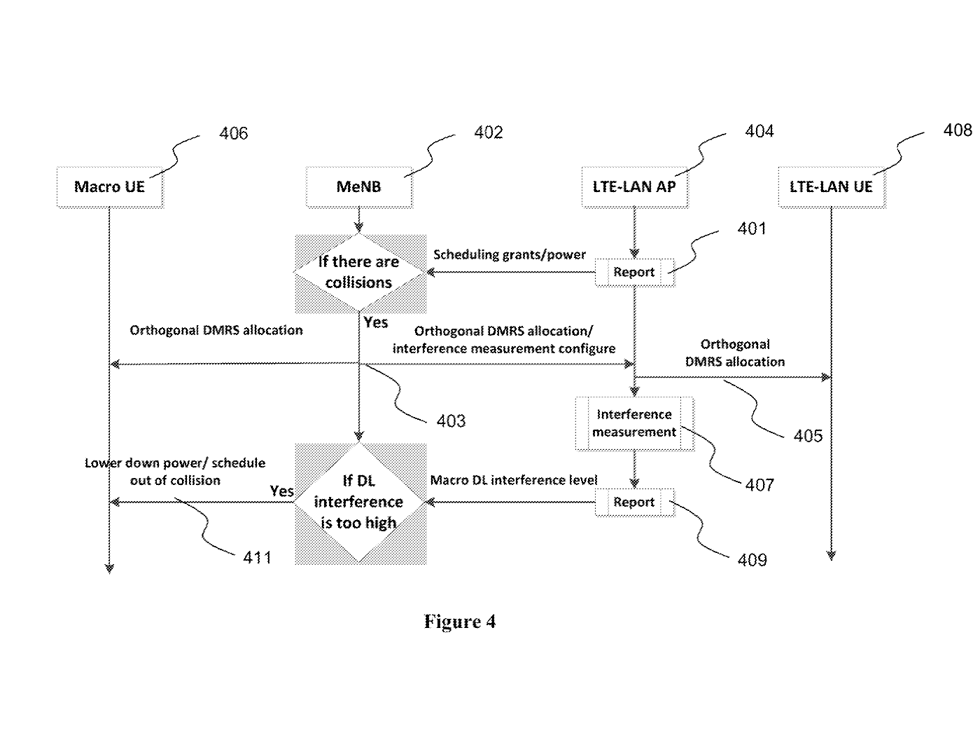

FIG. 4 illustrates a flow diagram of interference suppression according to an example embodiment of the application, where a portable LTE-LAN is at a middle distance from a macro eNB. By middle distance it is meant in this context an intermediate distance between near and far. In FIG. 4, a portable LTE-LAN is assigned to a DL resource of the macro cell. At 401, a portable LTE-LAN AP 404 may report to a macro eNB 402 the radio resource that it may assign or use. The radio resource can be, for example, a scheduling grant assigned to individual LTE-LAN UEs 408 inside a coverage area of the LTE-LAN AP 404, or a transmission power of the LTE-LAN AP 404. If there is transmission collision between LTE-LAN and the downlink of macro eNB, MeNB 402 may assign orthogonal DMRS at 403 to corresponding macro cell downlink channel for macro UE 406 and LTE-LAN AP 404. The LTE-LAN AP 404 can use at 405 the assigned orthogonal DMRS for its LTE-LAN downlink or/and uplink channels. In an example embodiment, MeNB 402 may indicate the LTE-LAN AP 404 to monitor and report an interference level to MeNB 402 based on the DMRS and the LTE-LAN AP 404 may responsively perform the interference measurement and report accordingly at 407 and 409. If the interference level is too high, MeNB can at 411 either lower down the transmission power or adjust a modulation coding scheme, MCS, level for macro DL or schedule a current macro DL transmission out of collision with the LTE-LAN by modifying resources used in macro DL. In an example embodiment, the LTE-LAN AP 404 and MeNB 402 may instruct their corresponding UEs 408 and 406 to utilize IRC receiver to reject interference through orthogonal DMRS.

In an example embodiment, if a portable LTE-LAN is near to a macro eNB, the major co-channel interference is from MeNB DL link since portable LTE-LAN is near to the MeNB. To avoid such interference, portable LTE-LAN may be assigned to macro cell UL resource. Potential interference from or to macro cell UL link may need some considerations because LTE-LAN and macro cell UL link may utilize different modulation and RS structure.

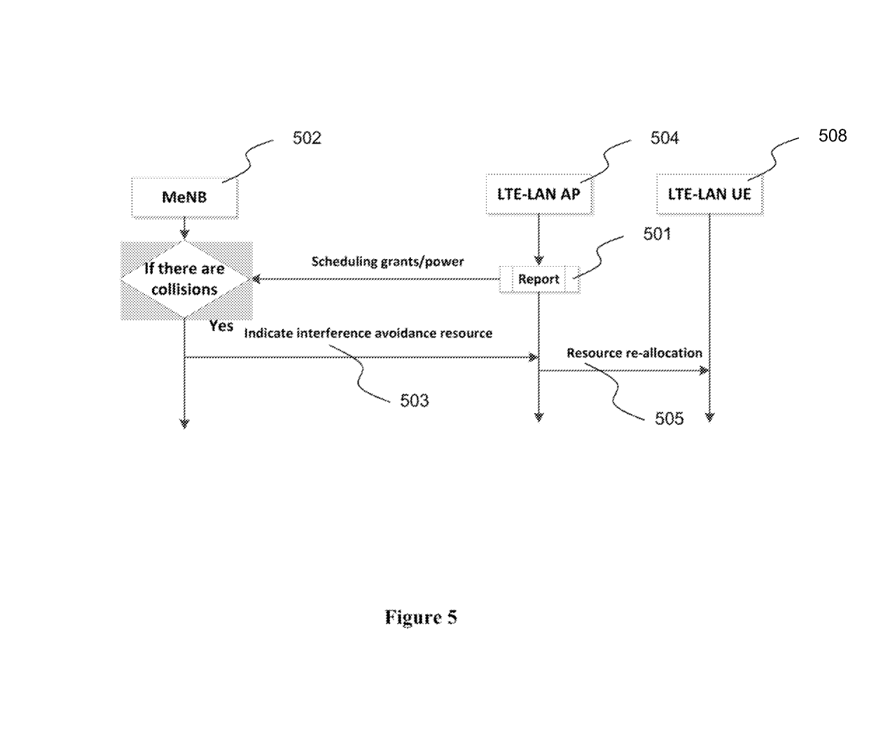

FIG. 5 illustrates a flow diagram of interference suppression according to an example embodiment of the invention, where a portable LTE-LAN is near to a macro eNB. In FIG. 5, a portable LTE-LAN is assigned to an UL resource of the macro cell. At 501, a portable LTE-LAN AP 504 may report to a macro eNB 502 the radio resource that it may assign or use. The radio resource can be, for example, a scheduling grant assigned to individual LTE-LAN UEs 508 under the coverage of the LTE-LAN AP 504, or a transmission power of the LTE-LAN AP 504. If there is a transmission collision between LTE-LAN and the uplink of macro eNB, MeNB 502 may notify the LTE-LAN AP 504 specific macro cell UL scheduling grants, or more generally macro UL resources, that LTE-LAN should avoid, for example, where such UL scheduling grants generate interference to the LTE-LAN from a UE near to the cell center, or the UL signals in such UL scheduling grants may be from a remote macro UE so interfered by the LTE-LAN. The LTE-LAN AP 504 can reallocate the resource at 505 for its LTE-LAN downlink or/and uplink channels. Alternatively MeNB 502 may notify which resources LTE-LAN may use, instead of indicating resources the LTE-LAN should avoid.

In an example embodiment, if a portable LTE-LAN is near to a macro eNB and the portable LTE-LAN is assigned to a macro cell UL resource, the portable LTE-LAN may also use the same modulation scheme and reference signal structure/pattern as what is used for macro cell UL, such as for example SC-FDMA. In this case, corresponding interference suppression mechnisms may be applied.

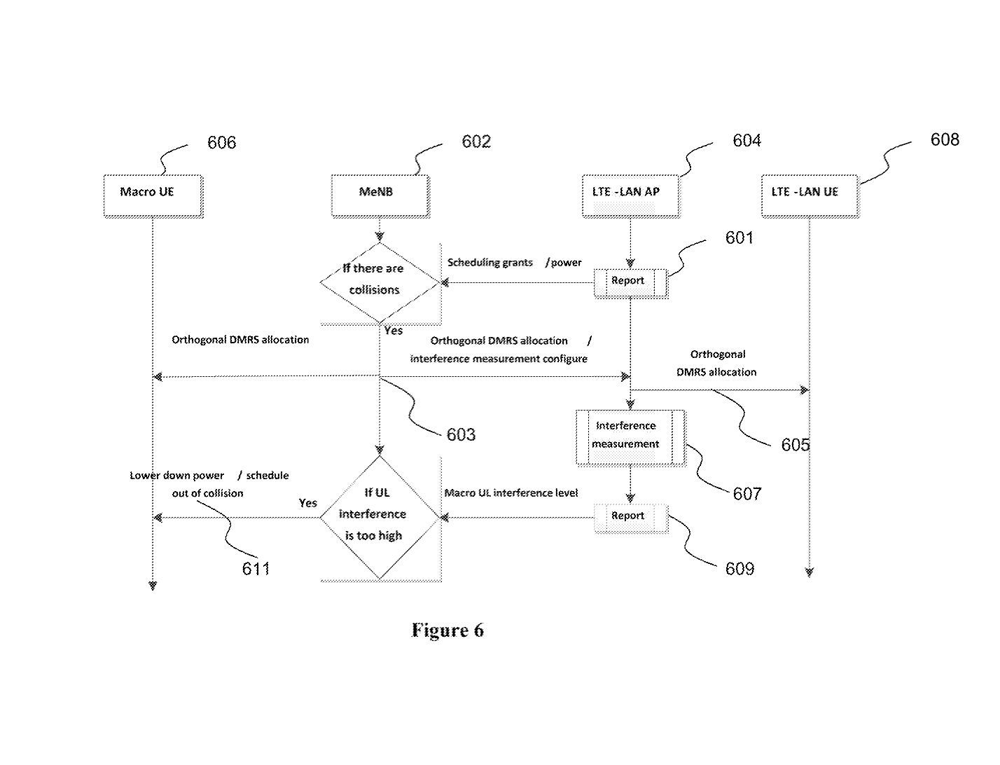

FIG. 6 illustrates a flow diagram of interference suppression according to an example embodiment of the application, where a portable LTE-LAN is near to a macro eNB and uses the same modulation scheme as the macro UL. In FIG. 6, a portable LTE-LAN is assigned to an UL resource of the macro cell. At 601, a portable LTE-LAN AP 604 may report to a macro eNB 602 the radio resource that it may assign or use. The radio resource can be, for example, a scheduling grant assigned to individual LTE-LAN UEs 608 under the coverage of the LTE-LAN AP 604, or a transmission power of the LTE-LAN AP 604. If there is transmission collision between LTE-LAN and the uplink of macro eNB, MeNB 602 may assign orthogonal DMRS at 603 to corresponding macro cell uplink channel for macro UE 606 and LTE-LAN AP 604. The LTE-LAN AP 604 can use at 605 the assigned orthogonal DMRS for its LTE-LAN downlink or/and uplink channels. In an example embodiment, MeNB 602 may indicate the LTE-LAN AP 604 to monitor and report interference level to MeNB based on the DMRS and the LTE-LAN AP 604 may responsively perform the interference measurement and report accordingly at 607 and 609. If the interference level is too high, MeNB can at 611 either lower down the transmission power or schedule current macro UL out of collision with the LTE-LAN. In an example embodiment, the LTE-LAN AP 604 and MeNB 602 may indicate their corresponding UEs 608 and 606 to utilize IRC reception to reject interference through orthogonal DMRS.

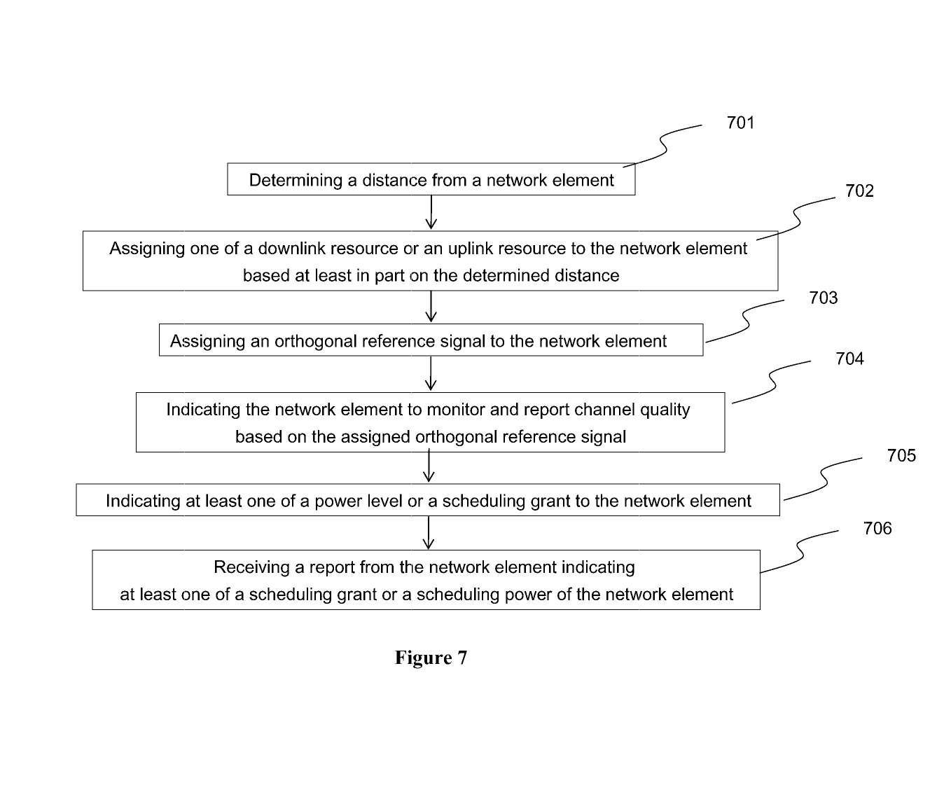

FIG. 7 illustrates a flow diagram of operating a macro eNB according to an example embodiment of the application. At 701, the macro eNB, such as for example the macro eNB 101 of FIG. 1 or 201 of FIG. 2, determines a distance from a network element, such as for example the portable LTE-LAN AP 103 of FIG. 1 or the portable LTE-LAN AP in local areas 202 and 204 of FIG. 2. In an example embodiment, the network element is a dedicated LTE-LAN AP. In another example embodiment, the network element is a UE that is configured to perform the functionality of a LTE-LAN AP. In another words, in this embodiment it is a normal UE from macro eNB perspective while it is an AP from the device point of view in the local area network. At 702, the macro eNB assigns one of a downlink resource or an uplink resource to the network element based at least in part on the determined distance. The assigned resource may be a frequency spectrum band or a subframe and will be used by the network element for both downlink and uplink communication with the devices served by the network element.

In an example embodiment, the macro eNB may optionally assign an orthogonal reference signal to the network element at 703. In an example embodiment, the macro eNB may optionally instruct the network element to monitor and report channel quality based on the assigned orthogonal reference signal at 704. At 705, the macro eNB may optionally indicate at least one of a power level or a scheduling grant to the network element. The power level may be adopted by the network element to prevent a too low or too high power of the LTE-LAN. The scheduling grant may be a macro cell DL and/or UL scheduling grant that the LTE-LAN should avoid in order to minimize collision. At 706, the macro eNB may, optionally, receive a report from the network element indicating at least one of a scheduling grant or a scheduling power of the network element.

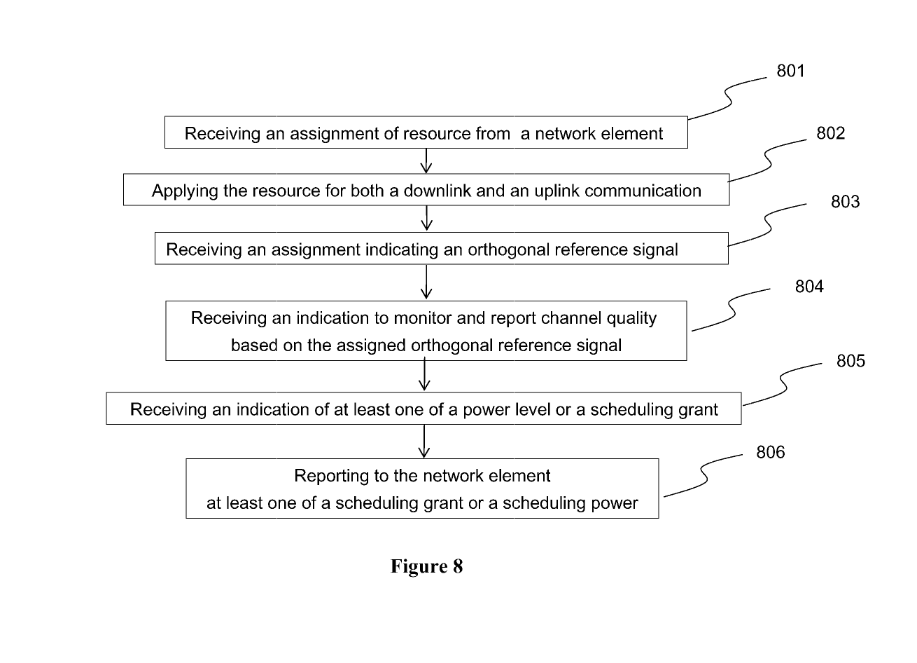

FIG. 8 illustrates a flow diagram of operating a LAN AP, such as for example a LTE-LAN AP, according to an example embodiment of the application. At 801, the portable LAN AP, e.g., the LTE-LAN AP 103 of FIG. 1 or the portable LTE-LAN AP in local areas 202 and 204 of FIG. 2, receives from a network element, such as for example the macro eNB 101 of FIG. 1 or 201 of FIG. 2, an assignment of a resource. The assigned resource may be a frequency spectrum or a subframe, for example. At 802, the LAN AP applies the assigned resource for both downlink and uplink communication with the devices served by it.

In an example embodiment, the LAN AP may optionally receive an assignment indicating an orthogonal reference signal at 803. In an example embodiment, the LAN AP may receive an indication to monitor and report channel quality based on the assigned orthogonal reference signal at 804. At 805, the LAN AP may optionally receive an indication of at least one of a power level or a scheduling grant. The power level may be adopted by the LAN AP to prevent a too low or too high power of the LAN. The scheduling grant may be a macro cell DL or UL scheduling grant that the LAN should avoid in order to minimize collision, or alternatively that the LAN may use. At 806, the LAN AP may optionally send a report indicating at least one of a scheduling grant or a scheduling power.

Note that in the example embodiments illustrated so far, either a DL or an UL resource is assigned to the LAN, depending on the distance between the LAN and the MeNB. In another example embodiment, part of a DL resource and part of an UL resource may be both assigned to a LAN. For example, when a LAN, such as for example a LTE-LAN, is far from a MeNB, the MeNB may assign a DL resource to the LAN. Moreover, the MeNB may also allocate part of the UL resource to the LAN, if this part of UL resource is not scheduled for any macro UE that is near to the LAN and may incur significant interference to the LAN.

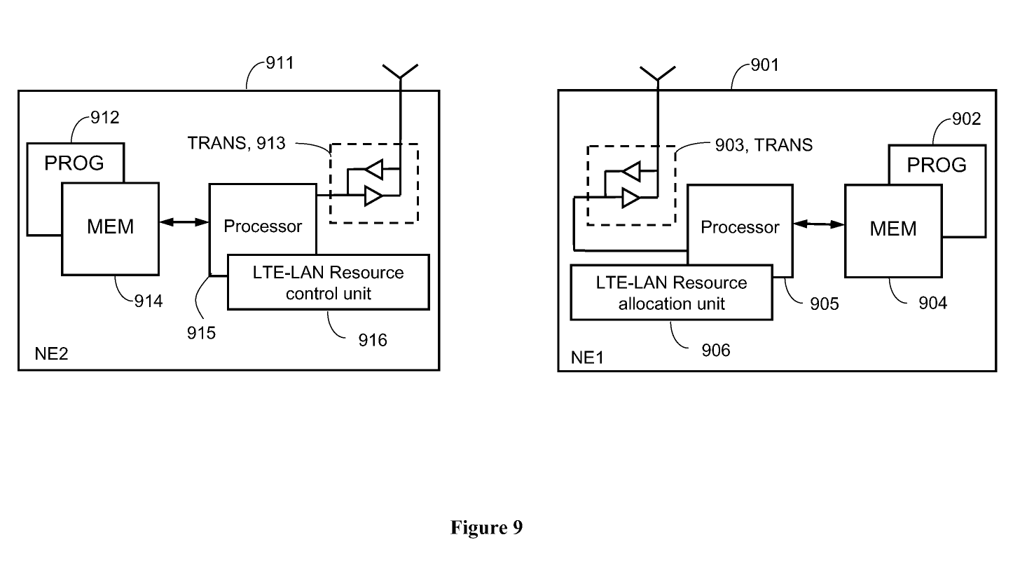

Reference is made to FIG. 9 for illustrating a simplified block diagram of various example apparatuses that are suitable for use in practicing various example embodiments of this application. In FIG. 9, a network element NE1 901, such as the macro eNB 101 of FIG. 1 or 201 of FIG. 2, is adapted for communication with another network element NE2 911, such as the LTE-LAN AP 103 of FIG. 1 or the portable LTE-LAN AP in local areas 202 and 204 of FIG. 2.

The NE1 901 includes a processor 905, a memory, MEM, 904 coupled to the processor 905, and a suitable transceiver, TRANS, 903 (having a transmitter, TX, and a receiver, RX) coupled to the processor 905. The MEM 904 stores a program, PROG, 902. The TRANS 903 is suitable for bidirectional wireless communications with the NE2 911. The NE1 901 is capable of being operably coupled to one or more external networks or systems, which are not shown in this figure.

The NE2 911 includes a processor 915, a memory, MEM, 914 coupled to the processor 915, and a suitable transceiver, TRANS, 913 (having a transmitter, TX, and a receiver, RX) coupled to the processor 915. The MEM 914 stores a program, PROG, 912. The TRANS 913 is capable of bidirectional wireless communications with the NE1 901.

As shown in FIG. 9, the NE1 901 may further include a LAN resource allocation unit 906 for determining a distance from a network element, and assigning one of a downlink resource or an uplink resource to the network element based at least in part on the determined distance. The unit 906, together with the processor 905 and the PROG 902, may be utilized by the NE1 901 in conjunction with various example embodiments of the application, as described herein.

As shown in FIG. 9, the NE2 911 may further include a LAN resource control unit for receiving an assignment of resource from a network element, and applying the resource for both a downlink and an uplink communication. The unit 916, together with the processor 915 and the PROG 912, may be utilized by the NE2 911 in conjunction with various example embodiments of the application, as described herein.

At least one of the PROGs 902 and 912 is assumed to include program instructions that, when executed by the associated processor, enable the electronic apparatus to operate in accordance with example embodiments of this disclosure, as discussed herein.

The example embodiments of this disclosure may be implemented by computer software or computer program code executable by one or more of the processors 905 and 915 of the NE1 901 and the NE2 911, or by hardware, or by a combination of software and hardware.

The MEMs 904 and 914 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The memory may be non-transitory in nature. The processors 905 and 915 may be of any type suitable to the local technical environment, and may include one or more of general purpose computers, special purpose computers, microprocessors, digital signal processors, DSPs, and processors based on single- or multi-core processor architecture, as non-limiting examples.

Without in any way limiting the scope, interpretation, or application of the claims appearing below, a technical effect of one or more of the example embodiments disclosed herein may be sharing a system resource between a macro cell and a LTE-LAN with reduced co-channel interference. This helps to improve the system throughput, and to optimize the LTE-LAN design. Although LTE is used throughout this document as an example, it is to be understood that the inventive principles described herein are not limited to a LTE environment but are applicable to any suitable system.

Embodiments of the present invention may be implemented in software, hardware, application logic or a combination of software, hardware and application logic. The software, application logic and/or hardware may reside on an apparatus such as a user equipment, a NodeB or other mobile communication devices. If desired, part of the software, application logic and/or hardware may reside on a macro eNodeB/base station 901, part of the software, application logic and/or hardware may reside on a LTE-LAN AP 911, and part of the software, application logic and/or hardware may reside on other chipset or integrated circuit. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

For example, while the example embodiments have been described above in the context of the LTE-LAN system, it should be appreciated that the example embodiments of this invention are not limited for use with only this one particular type of wireless communication system. For example, the example embodiments may be used to advantage in device to device, D2D, system.

Further, the various names used for the described parameters are not intended to be limiting in any respect, as these parameters may be identified by any suitable names.

If desired, the different functions discussed herein may be performed in a different order and/or concurrently with each other. Furthermore, if desired, one or more of the above-described functions may be optional or may be combined. As such, the foregoing description should be considered as merely illustrative of the principles, teachings and example embodiments of this invention, and not in limitation thereof.

1-40. (canceled)

41. A method, comprising:
determining a distance from a network element; and
assigning at least one of a downlink resource or an uplink resource to the network element based at least in part on the determined distance, wherein the assigned resource is used for both a downlink and an uplink communication of the network element.

42. The method of claim 41, further comprising:
assigning an orthogonal reference signal to the network element.

43. The method of claim 42, further comprising:
instructing the network element to monitor and report channel quality based on the assigned orthogonal reference signal.

44. The method of claim 41, further comprising:
indicating at least one of a power level and a scheduling grant to the network element.

45. The method of claim 41, further comprising:
receiving a report from the network element indicating at least one of a scheduling grant and a scheduling power of the network element.

46. An apparatus comprising:
at least one processor, and at least one memory including computer program code, wherein the at least one memory and the computer program code configured to, with the at least one processor, cause the apparatus to:
determine a distance from a network element; and
assign at least one of a downlink resource or an uplink resource to the network element based at least in part on the determined distance, wherein the assigned resource is used for both a downlink and an uplink communication of the network element.

47. The apparatus of claim 46, wherein the at least one memory and the computer program code configured to, with the at least one processor, cause the apparatus to:
assign an orthogonal reference signal to the network element.

48. The apparatus of claim 47, wherein the at least one memory and the computer program code configured to, with the at least one processor, cause the apparatus to:
instruct the network element to monitor and report channel quality based on the assigned orthogonal reference signal.

49. The apparatus of claim 46, wherein the at least one memory and the computer program code configured to, with the at least one processor, cause the apparatus to:
indicate at least one of a power level or a scheduling grant to the network element.

50. The apparatus of claim 46, wherein the at least one memory and the computer program code configured to, with the at least one processor, cause the apparatus to:
receive a report from the network element indicating at least one of a scheduling grant or a scheduling power of the network element.

51. A computer program product comprising a computer-readable medium bearing computer program code embodied therein for use with a computer, the computer program code includes code for:
determining a distance from a network element; and
assigning at least one of a downlink resource or an uplink resource to the network element based at least in part on the determined distance, wherein the assigned resource is used for both a downlink and an uplink communication of the network element.

52. The computer program product of claim 51, wherein the computer program code further comprises code for:
assigning an orthogonal reference signal to the network element.

53. The computer program product of claim 52, wherein the computer program code further comprises code for:
instructing the network element to monitor and report channel quality based on the assigned orthogonal reference signal.

54. The computer program product of claim 51, wherein the computer program code further comprises code for:
indicating at least one of a power level or a scheduling grant to the network element.

55. The computer program product of claim 51, wherein the computer program code further comprises code for:
receiving a report from the network element indicating at least one of a scheduling grant or a scheduling power of the network element.

56. A method, comprising:
receiving an assignment of resource from a network element, wherein the resource is at least one of a downlink resource or an uplink resource of the network element; and
applying the resource for both a downlink and an uplink communication with a device.

57. The method of claim 56, further comprising:
receiving an assignment indicating an orthogonal reference signal from the network element.

58. The method of claim 57, further comprising:
receiving an instruction from the network element to monitor and report channel quality based on the assigned orthogonal reference signal.

59. The method of claim 56, further comprising:
receiving an indication of at least one of a power level or a scheduling grant from the network element.

60. The method of claim 56, further comprising:
reporting to the network element at least one of a scheduling grant or a scheduling power.
